(19) United States
(12) Patent Application Publication
(10) Pub. No.: US 2017/0087051 A1
(43) Pub. Date: Mar. 30, 2017

(54) Stress Cone

(71) Applicant: Donald Oscar Deem, Hookstown, PA (US)

(72) Inventor: Donald Oscar Deem, Hookstown, PA (US)

(21) Appl. No.: 15/187,416

(22) Filed: Jun. 20, 2016

Related U.S. Application Data
(60) Provisional application No. 62/284,442, filed on Sep. 30, 2015.

(51) Int. Cl. A61H 23/02; A61H 39/04

(52) U.S. Cl. CPC A61H 23/02; A61H 39/04; A61H 2205/081; A61H 2201/013

(57) ABSTRACT

A stress cone (10) for massaging tight back muscles of a human body, the stress cone being a conical shaped body (11) with a rounded tip (12) at one end and an opposed concave base (14) at an opposed end. The stress cone (10) is typically made of solid rubber or other rigid but slightly compressible materials, and in some embodiments features a hollow core (18) for housing a vibrating motor (20). In use, the stress cone (10) is affixed to a wall via the concave base (14), and a user positions an identified pressure point of his or her body against the tip (12) and applies body pressure to the tip. The user can move side to side or up and down against the stress cone, massaging the muscles located at the pressure point to loosen them.

### CROSS REFERENCE TO RELATED APPLICATIONS

Reference is made to and priority claimed from U.S. provisional application Ser. No. 62/284,442 filed 30 Sep. 2015.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION BY REFERENCE OF MATERIAL SUBMITTED ON A COMPACT DISC OR AS A TEXT FILE VIA THE EFS WEB SYSTEM

Not applicable.

### STATEMENT REGARDING PRIOR DISCLOSURES BY THE INVENTOR OR A JOINT INVENTOR

Not applicable.

### BACKGROUND OF THE INVENTION

(1) Field of the Invention

The present invention pertains to the field of stress reducing apparatuses. More specifically, the present invention pertains to an apparatus used to relieve stress knots in a person's back.

(2) Background Art

Muscle tightness is a common problem for physical laborers and desk jockeys alike. Back pain from muscle tightness is suffered by about half of the adult population in the United States and costs the US economy millions of dollars in terms of lost work time, and medical treatments to alleviate pain. In its simplest form, muscle tightness can be alleviated with massage, but tightness in the muscles of the back are difficult to massage without the help of another person, and self-help is difficult, if not impossible.

What is needed is a device that is compact in size so as to be conveniently portable that allows an individual to easily self massage and alleviate muscle knots.

### BRIEF SUMMARY OF THE INVENTION

Accordingly, in a first aspect of the invention, a stress cone for massaging tight muscles is comprised of a conical shaped body having a rounded tip at one end and a concave base at an opposed end, the tip and the concave base made of a firm yet compressible material such as rubber.

In a second aspect of the invention, a hollow core and a battery powered motor are included in the stress cone, by forming a hollow into the conical shaped body to house the battery powered motor. In an advantageous embodiment, the battery powered motor when activated vibrates.

In a third aspect of the invention, the conical shaped body is a rigid core covered by an exterior skin covering at least one of the tip and the concave base, the exterior skin being made of rubber, silicone or compressible foam.

In yet a fourth aspect of the invention, the concave base of the stress cone is a suction cup.

### BRIEF DESCRIPTION OF THE DRAWINGS

The features and advantages of the invention will become apparent from a consideration of the subsequent detailed description presented in connection with accompanying drawings, in which:

FIG. 1 is a perspective view of a stress cone according to the invention.

FIG. 2 is a side elevation, cross sectional view of the stress cone in FIG. 1, taken along lines A-A, shown having an internal chamber and a vibrating battery and switch assembly.

FIG. 3 is a front view of a human back, showing possible suitable pressure points at which the stress cone of FIGS. 1 and 2 are positioned.

FIG. 4 is a side elevation view of a human shown with the stress cone positioned against a suitable pressure point, with the stress cone oriented in a use position against a wall.

### DRAWINGS LIST OF REFERENCE NUMERALS

The following is a list of reference labels used in the drawings to label components of different embodiments of the invention, and the names of the indicated components.
10 stress cone
11 body
12 tip
14 base
16 body
18 hollow core
20 motor with switch assembly
22 pressure point
24 user
26 wall

### DETAILED DESCRIPTION

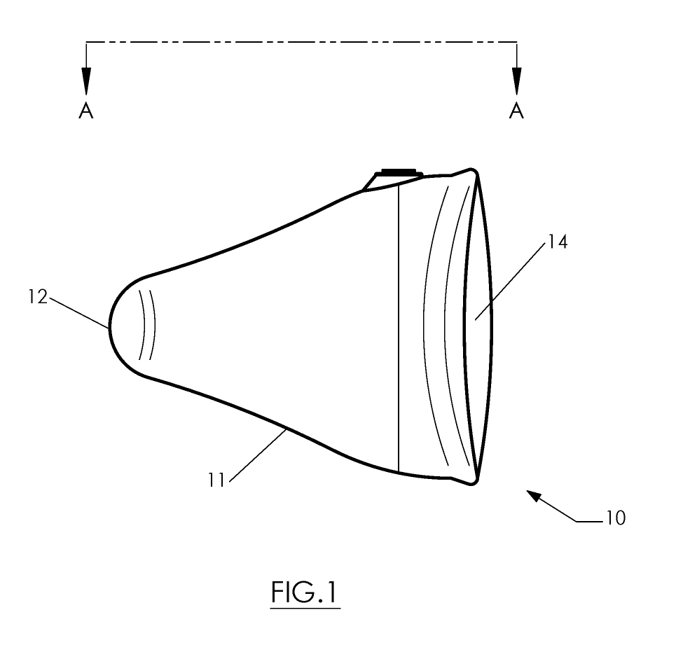

A stress cone 10 according to the invention is shown in FIGS. 1-4.

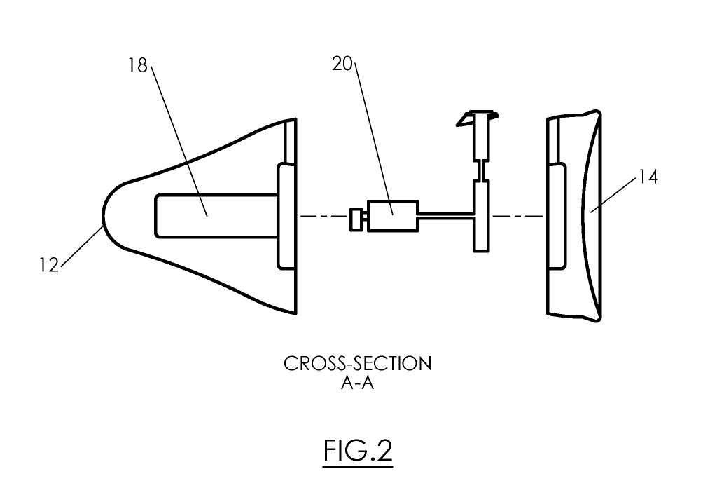

Turning now to FIGS. 1 and 2, the stress cone 10 is a conical shaped body 11 approximating a badminton shuttlecock in size and general shape. The stress cone approximate length ranges between 1.5-5 inches, and 0.5-1 inches thick at a tip 12, and 2-4 inches wide at a base 13. The stress cone 10 is ideally made of solid rubber, but can also be made with a plastic or rigid foam core covered with a rubber, silicone, or soft foam skin, of a sufficient thickness so as to allow some limited compression of the stress cone 10 during use. The tip 12 of the stress cone is rounded, and at a base 14 is formed as a slight concave to serve as a means for holding the stress cone to a wall or other surface. In its simplest form, the base 14 is a suction cup suctioning the stress cone 10 to the wall or other surface during use. The suction cup is naturally formed during construction of the stress cone when the cone is made of a rubber material; when other materials are used, such as a plastic core, an exterior skin made of rubber, silicone, etc. is formed so as to create a slight concave bottom to serve as a suction cup. The rubber material most suitable for use with the stress cone is firm but not completely rigid, so as to be slightly compressible during use.

In a first embodiment of the stress cone 10, the stress cone features a solid core. In a second embodiment, shown in FIG. 2, the stress cone features a hollow core 18 for housing a motor with a switch assembly 20. In a typical embodiment, the motor with the switch assembly 20 is completely encapsulated by the stress cone material, however the inventors also believe a removable motor is also suitable. The motor and switch assembly 20 is battery powered, and cycled on/off via a push switch. Pressing on the push switch cause the motor to vibrate the stress cone, and thus increases a massaging ability of the stress cone 10.

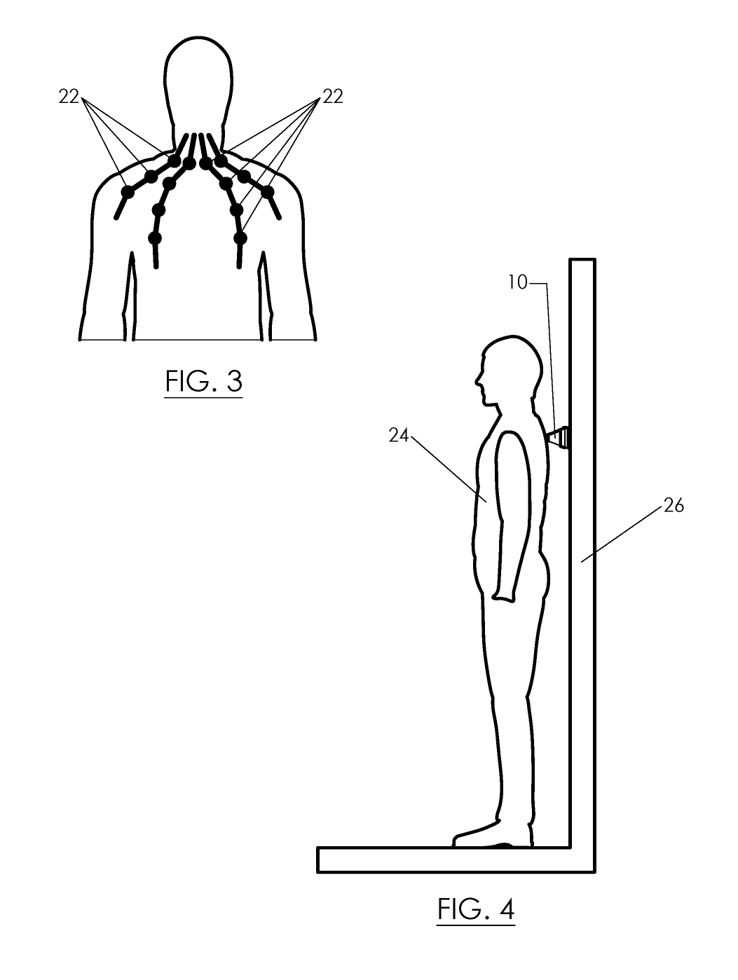

FIGS. 3 and 4 show how to use stress cone 10. First, a pressure point 22 is identified, and in FIG. 3, a plurality of common useful pressure points 22 are shown. A user 24 places the stress cone 10 against a wall 26, pressing the base 14 firmly against the wall 26 to engage the base 14. The user 24 then leans back onto the tip 12 of the stress cone 10, applying pressure to the stress cone 10 at a desired location of the pressure point 22. Pressing on the tip 12, or alternatively an on/off button, in embodiments having the internal motor, activates the motor and causes the stress cone to vibrate. In other embodiments (not shown), the motor can be engaged separately by squeezing the stress cone rather than applying pressure to the tip 12 or to an on/off button. In all embodiments, applying body pressure on the pressure point 22 against the tip 12 of the stress cone 10 and then optionally moving the user's back from side to side, up or down, or in circular motions about the tip 12 of the stress cone 10 causes the pressure point to be massaged and tight muscles at the pressure point to be relaxed. The rounded tip 12 of the stress cone provides a comfortable, slightly compressible but firm point that is uniquely adapted to massaging tight muscles. The conical body 11 provides stability and allows the stress cone 10 to be a relatively small size for portability and convenient storage in a purse or pocket.

It is to be understood the above-described arrangements are only illustrative of the application of the principles of the present invention. Numerous modifications and alternative arrangements may be devised by those skilled in the art without departing from the scope of the present invention. The inventors note that the stress cone can also be configured with a rubber or other firm/slightly compressible material tip 12 affixed to a hard body such as solid plastic, with a conventional suction cup attached to the base 14 in lieu of the disclosed design in the Figures. The main features of the stress cone are the rigid yet slightly compressible nature of the stress cone, to allow for comfortable massaging of the muscles, the sturdy self-affixing base for ease of use against a wall, and the rounded tip to effectively massage the muscles rather than jab uncomfortably at them if a relatively small pointy tip was used instead. The inventor also notes that the internal motor, shown in the Figures, is one suggested type of internal motor suitable for use with the stress cone, and is not meant to limit the internal motor type to only what is shown in the Figures. Other internal motors, if of a suitable size and functionality, can also be used with the invention as described herein.

What is claimed is:

1. A stress cone (10) for massaging tight muscles, comprising:
a conical shaped body (11) having a rounded tip (12) at one end and a concave base (14) at an opposed end; and
wherein at least one of the tip (12) and the concave base (13) is made of a compressible material.

2. The stress cone (10) of claim 1, wherein the compressible material is rubber.

3. The stress cone (10) of claim 1, further comprising a hollow core (18) formed in the body (11).

4. The stress cone (10) of claim 3, further comprising a battery powered motor and switch assembly (20) housed in the hollow core (18).

5. The stress cone (10) of claim 4, wherein the battery powered motor and switch assembly (20) is a vibrating motor.

6. The stress cone (10) of claim 1, wherein the conical shaped body (11) is further comprised of an exterior skin covering at least one of the tip (12) and the concave base (13).

7. The stress cone (10) of claim 6, wherein the conical shaped body (11) is a rigid core covered by the exterior skin.

8. The stress cone (10) of claim 7, wherein the exterior skin is rubber.

9. The stress cone (10) of claim 7, wherein the exterior skin is silicone.

10. The stress cone (10) of claim 1, wherein the concave base (14) is a suction cup.

11. The stress cone (10) of claim 1, wherein the conical shaped body is 1.5-5 inches long from the tip (12) to the base (14) and wherein the tip (12) is at least 0.5-1 inches wide.

12. The stress cone (10) of claim 11, wherein the base (14) is at least 2-4 inches wide.
